(19) United States
(12) Patent Application Publication
(10) Pub. No.: US 2003/0138969 A1
(43) Pub. Date: Jul. 24, 2003

(54) Closed substrate platforms suitable for analysis of biomolecules

(76) Inventors: Mogens Havsteen Jakobsen, Vanlose (DK); Lars Kongsbak, Holte (DK)

Correspondence Address: EDWARDS & ANGELL, LLP, P.O. BOX 9169, BOSTON, MA, 02209, US

(21) Appl. No.: 10/057,841

(22) Filed: Jan. 24, 2002

(51) Int. Cl. G01N 1/10

(52) U.S. Cl. 436/180; 422/99; 422/100; 422/102; 422/946; 422/947; 435/283.1; 435/287.2; 435/288.3; 435/288.5

(57) ABSTRACT

The invention relates to novel analysis slides or substrates with a closed configuration. The slides may be used for any application which normally utilizes a conventional microscope slide and can be used in conjunction with any type of equipment typically used to manipulate or evaluate a standard microscope slide. In particular, the invention provides closed slides for covalent immobilization of polypeptides and nucleic acids. Further provided are methods for carrying out biological assays using arrays of biomolecules immobilized on the slides of the invention. The arrays of the invention are comprised of a unique meandering or straight channel design as compared to the rectangular design of conventional arrays.

### BACKGROUND OF THE INVENTION

1. Field of the Invention

The invention relates to novel platforms, particularly slides and compartments such as microscopic slides, of closed configurations. The slides may be used for any application which normally utilizes a conventional microscope slide and can be used in conjunction with any type of equipment typically used to manipulate or evaluate a standard microscope slide. In particular, the invention provides for closed slides for covalent immobilization of biomolecules, e.g. peptides, polypeptides, nucleic acids, nucleic acid binding partners, proteins, receptors, antibodies, enzymes, oligo saccharides, polysaccharides, cells, arrays of ligands (e.g. non-protein ligands), and the like. Further provided are methods for carrying out biological assays using arrays of biomolecules immobilized on the slides of the invention.

2. Background

The development of bio-array technologies promises to revolutionize the way biological research is carried out. Bio-arrays, wherein a library of biomolecules is immobilized on a small slide or chip, allow hundreds or thousands of assays to be carried out simultaneously on a miniaturized scale. This permits researchers to quickly gain large amounts of information from a single sample. In many cases, bio-array type analysis would be impossible using traditional biological techniques due to the rarity of the sample being tested and the time and expense necessary to carry out such a large scale analysis.

Although bio-arrays are powerful research tools, they suffer from a number of shortcomings. For example, bio-arrays tend to be expensive to produce due to difficulties involved in reproducibly manufacturing high quality arrays. Also, bio-array techniques can not always provide the sensitivity necessary to perform a desired experiment. Therefore, it would be desirable to provide an improved platform for the production of arrays which results in a less expensive, more reproducible and more sensitive bio-array.

There are two fundamentally different approaches to the manufacturing of bio-arrays: 1) “in situ synthesis” and 2) “micro spotting”. The in situ synthesis approach involves monomer-by-monomer synthesis directly on the substrate carrier. This approach has some inherent drawbacks as the synthesis of oligomers includes many chemical steps which never provide 100% yield. Thus, bio-arrays produced via the in situ synthesis strategy generally contain truncated sequences leading to differences in the composition from array to array. The micro spotting approach involves dispensing of biomolecules onto the substrate carrier followed by immobilization of the molecules onto the surface. This approach offers the advantage that materials can be obtained from natural sources, or synthesized on standard synthesizers, purified and characterized prior to construction of the array. Thus, bio-arrays produced by the micro spotting approach generally are more reproducible and of higher quality than bio-arrays produced by the in situ synthesis approach.

### SUMMARY OF THE INVENTION

The present invention provides novel substrate analysis platforms that can be employed in a variety of scanning or analysis apparatus, including applications or instruments which normally employs a standard microscope slide. A preferred use of the platforms is the immobilization of biomolecules for investigation of biomolecule interactions. The microfluidic analysis platform design of the closed substrate platform can allow for use of reduced volumes of sample and buffers as compared to conventional arrays.

In an embodiment of the invention, a closed substrate platform is provided, which comprises an area for sample analysis and a microfluidic analysis platform enclosed in a container. The design of the analysis platform allows for fluid sample, injected through a narrow inlet port connected to a narrow tube. The inlet preferably comprises an adapter which fits into the inlet port and is conical in shape. The top part of the adapter is constructed to receive a fluid delivery device such as a pipette or a syringe needle. The adapter is comprised of rubber or a silicon-based material so that there is a tight contact between the pipette tip or syringe needle when fluid is delivered. The fluid travels from the adapter to the analysis area through a canal which is interrupted by a flow restrictor. The flow restrictor can allow the fluid sample to be distributed evenly through the analysis area when pressure is applied by a user or automated system. The analysis area is preferably a straight and narrow canal with no turns. At a defined area, probes (discussed infra) can be attached to the bottom of the canal. The fluid travels from the analysis area through a canal and arrives at a buffer chamber. Connected to the buffer chamber is a short capillary canal that preferably opens into a meandering design waste area. The waste area ends in a vent, shaped as a capillary chamber.

In another embodiment, a slide article or substrate analysis platform comprising shallow depressions on the top and/or bottom surfaces is provided. The depression on the bottom and/or top surface is preferably arranged in connection with the area for sample analysis and can prevent the slide from becoming scratched during handling and can provide an effective system of temperature control. The substrate platform preferably contains finger indentations to aid in removal of the platform from a flat surface.

In another preferred embodiment, the closed substrate platform is comprises two parts adhered to each other, at the interface of which the microfluidic analysis platform is defined. In particular, a first bottom part having depressed in a planar surface thereof, a defined channel system is adhered to a second part, preferably a planar plastic member or film at the planar surfaces of the first part. The adhering of the two parts may be performed by using heat and/or adhesive optionally followed by a physical pressure to ensure a tight sealing and prevent any liquid or gas escaping through the seal. This has the advantage of providing for a thin substrate platform that can be used in many applications or instruments which normally employ a standard microscope slide.

In another preferred embodiment, a closed substrate platform is provided wherein the substrate is at least partially enclosed within a container that is preferably substantially sealed. The container provides ports for introduction of fluid into the container and venting of air out of the container. The ports connect to an integrated microfluidics system that permits sample loading and buffer washing without opening the sealed container. An outlet port and waste area within the container are also provided for expelling and containing waste materials.

The substrate platforms are preferably constructed of a polymer with low intrinsic fluorescence emission. Preferably the polymer is resistant to extremes of temperature (high and low), sonication and a wide variety of solvent conditions, such as extremes of pH, high ionic strength or organic solvents. Preferred polymers include polycarbonate, Topas (trade name; available from Hoechst). Other suitable materials for construction of the analysis platforms of the invention include e.g. polyethylene, polypropylene, polystyrene, polymethylacrylate, and the like.

Slides or substrate platforms of the invention may be used for any type of application which may be carried out using a standard microscope slide. For example, the slides or analysis platforms may be used for microscopic analysis of samples, smears, sections, etc. Other types of applications include e.g. diagnostics; SNP analysis; gene expression including e.g. detection of intron/exon splicing, and to evaluate if expression of certain genes is modulated by drug candidates); toxicology studies including toxicology on cells; protein-to-protein interactions; plant and animal breeding studies; environmental studies; and the like.

Slides or analysis platforms of the invention may be suitably used in conjunction with any type of a wide variety of analysis equipment, materials or reagents, including equipment, materials and reagents used with standard microscope slides, such as e.g. coverslips, slide washers, pipettors, inkjet printers or spotters, or robotics systems. Additionally, the slides or analysis platforms of the invention may be analyzed using any type of instrument or device capable of analyzing or reading a standard microscope slide including, for example, microscopes, scanners, readers, imagers, or the like.

The invention also provides immobilized biomolecules on the surface of the substrate. Preferably, nucleic acid, nucleic acid binding partners, proteins, antibodies, polysaccharides or polypeptides are immobilized in an array wherein each unique sequence is located at a defined position on the substrate. The arrays preferably contain at least about 10 to about 100 unique sequences per cm². Immobilized nucleic acids preferably contain from about 2 to about 5000 nucleotides, more typically 2 to about 1000 nucleotides, and polypeptides preferably contain from about 2 to about 5000 amino acids.

Immobilized nucleic acid chains of the invention preferably contain at least one LNA nucleoside analogue. LNA nucleoside analogues are disclosed in WO 99/14226. Also provided are oligomers composed entirely of LNA nucleosides. Immobilized nucleic acids may be either single stranded or double stranded.

Biomolecules are preferably immobilized onto the substrate using a photochemical linker, preferably a photoreactive linker, such as a photoreactive ketone, or particularly a photoreactive quinone such as disclosed in WO 96/31557. Also provided are flexible linkers which can serve as a spacer between the substrate surface and the biomolecule. Nucleic acid, polysaccharide and polypeptide chains are preferably immobilized via one end of the chain.

The invention also provides methods for carrying out biological assays using the substrate platforms and fluidic devices of the invention. A wide variety of assays may be carried on the analysis platforms and fluidic devices of the invention, including any type of assay which may be carried out using a standard microscope slide.

Specific examples include assays wherein one component is immobilized on the surface of the slide. Preferred assays involve immobilized arrays of polypeptide or nucleic acid sequences which may be exposed to a biomolecule (i.e. a nucleic acid, polypeptide, hormone, small molecule drug or drug candidate, etc.) under conditions which favor interaction between the biomolecule and the immobilized molecules. Preferably, interactions between the molecules are detected by virtue of a detectable feature on the biomolecule, e.g. a chemoluminescent tag such as an enzyme, a radiolabel (e.g. ¹²⁵I, tritium ³²P, ⁹⁹Tc, and the like); fluorescent tag; or an inducible tag e.g. a functional group that is activated by energy input such as electric impulse, radiation (e.g. UV radiation); and the like. The methods of the invention may be used e.g. to investigate interactions between nucleic acid-nucleic acid, nucleic acid-polypeptide, polypeptide-polypeptide, etc. Particularly preferred assays which may be performed using the methods of the invention include gene expression profiling; immunoassays; diagnostics; SNP analysis; gene expression including e.g. detection of intron/exon splicing, and the like.

Slides or analysis platforms of the invention may also be used for applications or assays not involving immobilized biomolecules.

Other aspects of the invention are disclosed infra.

### BRIEF DESCRIPTION OF THE DRAWINGS

FIG. 1 (which includes FIGS. 1A and 1B) shows a top and cross-sectional view of the adapter.

FIG. 2 (which includes FIGS. 2A and 2B) shows a top view of a substrate platform and an enlarged part of the buffer chamber.

### DETAILED DESCRIPTION OF THE INVENTION

The present invention provides for closed substrate platforms which are a significant improvement over standard microscope slides and other biomolecule analysis systems. The substrate platforms are preferably used for the immobilization of biomolecules, but may be used for any application normally utilizing a microscope slide.

Preferred closed substrate platforms of the invention comprise in combination a container that comprises an area for sample analysis and a microfluidic analysis platform, wherein the container comprises (i) at least one inlet for the introduction of fluid to the sample analysis area and (ii) an outlet for removal of fluid from the sample analysis area; and the substrate platform preferably further comprising a vent for expulsion of air from the container.

References to the “container” of the substrate platform are inclusive of a variety of configurations, such as e.g. any type of system that provides a substantially closed fluid path. Preferred containers of substrate platforms of the invention are discussed infra and exemplified in Figures.

Preferred analysis substrate platforms of the invention comprise a container comprising an area for sample analysis and a microfluidic analysis platform. The container comprises (i) at least one inlet for the introduction of fluid to the sample analysis area and (ii) an outlet for removal of fluid from the sample analysis area. The container comprises or is composed of at least two parts adhered to each other, and those two parts define at least a portion of the microfluidic analysis platform. The mated two parts suitably can define the entire or substantially entire microfluidic analysis platform.

In that preferred system, the first part in a planar surface thereof has depressed a defined channel system and a second substrate platform part is a planar substrate adhered to the first part planar surface. Suitably, the two parts are suitably adhered by any number of approaches, preferably by an adhesive. The second part is preferably a transparent member, particularly a transparent plastic member which can be a flexible film layer. The first part also may preferably be formed of a plastic.

The substrate platform may be pre-loaded with one or more biomolecules. For example, the sample analysis area may be loaded with one or more biomolecules such as oligonucleotides or an antibody for use in a capture-type assay with a fluid test sample added to the substrate through one or more inlets in the of the substrate platform. Alternatively, all reagents for an analysis reaction may be introduced into the substrate platform substantially simultaneously, or at least sequentially but without significant (e.g. >0.5 or 1 hour) delay between the sequential additions. Other approaches for introduction of biomolecules into a substrate platform of the invention also will be suitable.

The substrate platform comprises a microfluidic analysis platform which preferably comprises the sample analysis area. The microfluidic analysis platform or system also provides for flow of an introduced fluid sample through the substrate platform.

The microfluidic analysis platform can comprise a non-linear meandering flow path. Also, preferably, the substrate platform comprises a plurality of inlets, particularly two inlets, where one inlet can be utilized for introduction of a fluid test sample into the substrate platform, and the other inlet can be utilized for introducing a fluid sample other than a test sample, such as a buffer or wash solution. Preferably, each inlet comprises an adapter for receiving a fluid introduction or delivery device such as a pipette, syringe, etc. Preferably the adapter fits the fluid delivery device with a substantially fluid-tight or impervious seal or engagement. Rubber or silicone-based adapters are particularly suitable. The adapter also is preferably conically-shaped to facilitate mating of a fluid delivery device with an inlet opening.

Preferred substrate platforms of the invention are designed whereby the delivery of fluid into the substrate platform provides force for fluid flow through the substrate platform. That fluid flow can be modulated if desired, preferably by incorporation of a fluid flow modulator unit in the microfluidic flow path. Preferably, the fluid flow modulator is a capillary channel of reduced cross-sectional area than the preceding flow path and functions to reduce the rate of fluid flow. Preferably, such a fluid flow modulator is positioned prior to an analysis area in the fluid flow path.

Preferred substrate platforms of the invention also may contain a buffer area that is downstream (in the microfluidic fluid flow path) from the analysis area. It is also preferred that a fluid waste area is positioned downstream (in the microfluidic fluid flow path) from the analysis area as well as the buffer area, in those systems that contain a buffer area. Preferably, the vent of the substrate platform is in communication with the waste area.

As discussed above, such substrate analysis platforms of the invention are preferably used for sample analysis, such as for detecting DNA sequence variation, DNA sequencing, SNP analysis, genotyping, deletion analysis, gene expression and the like. In use, a test sample suitably may be introduced into the substrate platform and the sample then evaluated, typically when positioned within the analysis area, e.g. by a scanner to detect a hybridization reaction or other molecular coupling reaction.

The invention also provides methods for producing particularly preferred substrate platforms. In particular, a substrate platform base is provided which comprises an open top (without closure structure) microfluidic flow path as well as analysis area and other structures as may be preferably present such as a buffer area and/or waste area. A planar substrate, preferably plastic is then affixed to the top of the structure to provide a substantially closed system. That is, the “open-top” structure is substantially sealed with the planar substrate, which preferably is a plastic layer. That layer is suitably laminated or otherwise affixed such as by use of heat, an adhesive and/or pressure.

As used herein the term “substrate platform”, “analysis platform”, “hybridization chamber” or “slide element” or similar term refers to the foundation upon which biomolecules may be immobilized, samples may be applied for analysis or biological assays may be carried out. The terms “substrate platform”, “fluidic device”, “microfluidic structure”, “analysis platform”, “hybridization chamber”, “slide element” and ‘slide’ or “microscope slide” may be used interchangeably, however, where applicable, the term substrate platform refers to the entire structure including the part of the slide to which the sample is applied.

As used herein, “microfluidic” refers to the volumes of sample that can be used in the sample analysis area, for example at least about 4 μl suitably up to about 6 or 7 μl or more such as up to about 10, 15, 20, 25, 30, 40, 50, 60, 70, 80, 90 or 100 μl.

As used herein the term “microscope slide” or “standard microscope slide” refers to any type of slide which falls within the parameters recognized in the art. For example, in the United States, typical slide elements have dimensions of 1 inch×3 inches. In Europe, typical slide dimensions include 25 mm×75 mm, or 26 mm×76 mm. Typical slide thickness are from about 1 mm to about 1.3 mm.

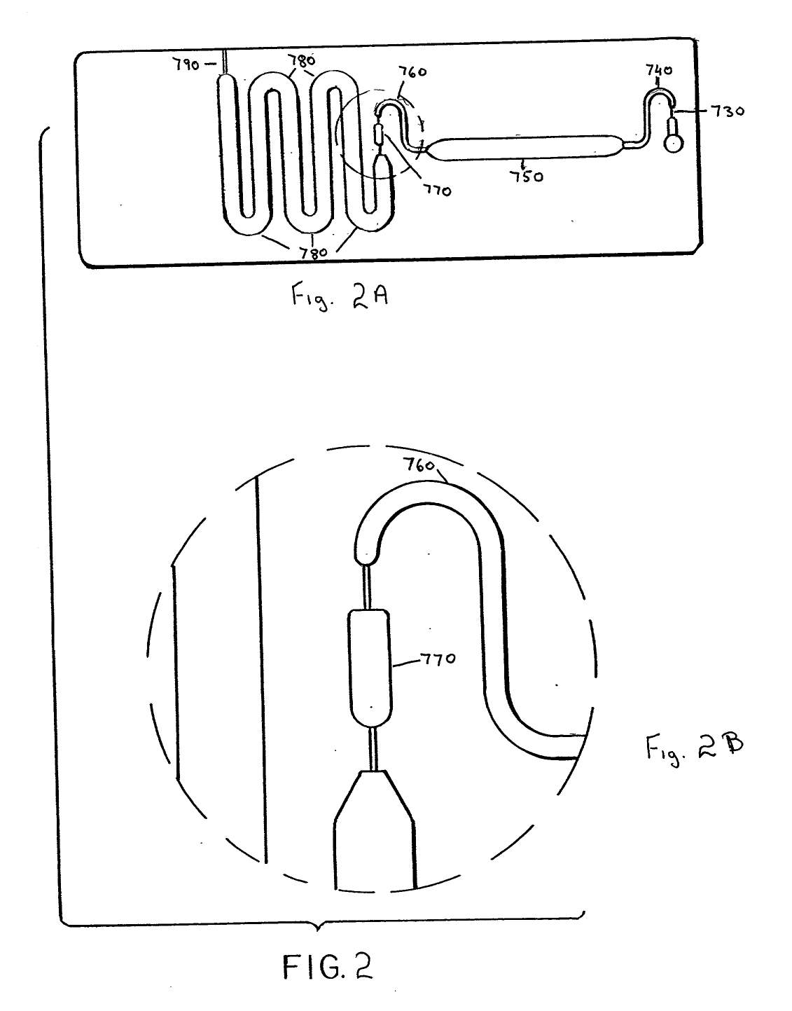

The term “meandering design” and the like refers to a non-linear sample (fluid) flow path through a substrate analysis platform of the invention. Preferred meandering flow paths have one or more preferably a plurality of looped-back or substantially S-shaped turns in the flow path. A particularly preferred meandering flow path comprises at least one substantially “S-like” shape wherein a series of straight parallel tubes end in 180⁰ semi-circular turn leading into another straight tube running parallel to the previous tube, and so forth, thereby forming the meandering design or any “S” shape variations thereof (see for example, FIG. 2A). Other suitable meandering flow paths include spiral-shaped flow paths, a flow path that has orthogonally arranged portions, and the like.

As used herein, the term “straight channel” refers to the shape of the substrate analysis area which is characterized by a straight tube.

As used herein, the term “airtight” refers to the sealing of the top and bottom sections of the substrate platform such that air or fluids cannot leak through the seal.

The substrate platform may be constructed from a variety of materials such as plastics, quartz, silicon, polymers, gels, resins, carbon, metal, membranes, glass, etc. or from a combination of several types of materials such as a polymer blend, polymer coated glass, silicon oxide coated metal, etc. Particularly preferred substrate materials are polymers which contain a low intrinsic fluorescence emission, such as polycarbonate, Topas (trade name; available from Hoechst), polymethyl methacrylate (PMMA), and the like. In another preferred embodiment, the closed substrate platform is comprised of two parts adhered to each other, at the interface of which the microfluidic analysis platform is defined. In particular, a first bottom part having depressed in a planar surface thereof, a defined channel system is adhered to a second part, preferably a planar plastic member or film at the planar surfaces of the first part. The adhering of the two parts may be performed by using heat and/or adhesive optionally followed by a physical pressure to ensure a tight sealing and prevent any liquid or gas escaping through the seal.

The term “plastics” as used herein refers to polymers, such as thermoplastic polymers. The plastic is used in the manufacture of microfluidic devices. Such devices include, but are not limited to: miniature diagnostic systems for biopharmaceutical applications, miniature devices for directing fluid flow, miniature sensor devices for pharmaceutical and biochemical applications, and three-dimensional microfluidic systems. When used in these applications, it is suitable that the plastic is selected from the group consisting of homopolymers and copolymers of polycarbonate, polystyrene, polyacrylic, polyester, polyolefin, polyacrylate, and mixtures thereof.

The term “clarity” as used herein, is the degree of absence of impurities which may impair the passage of light through the slide and is measured by the amount of light that can pass through the slide, measured at a wavelength of preferably 530 nm. The amount of light relative to air passing through the slide is preferably at least 75% of total light from the light source, more preferably 85%, most preferably 90%.

The term “low intrinsic fluorescence” as used herein refers to a material or substrate which emits less than about 50 percent of the detected signal of a test sample on the substrate, thereby providing a signal:noise ratio at detection levels of 2:1.

Particularly preferred are slides or substrate platforms with an area for sample analysis that have a flatness of less than or equal to about 20 μm, wherein the flatness does not deviate on a slide and between slides, more than 1 μm per millimeter. Preferably the slide has a roughness of about an RA of less than about 100 nm, preferably an RA of less than about 50 nm, more preferably an RA of less than about 20 nm.

Preferably, the substrate platform is constructed of a material that is capable of covalently binding to a biomolecule without activating the surface of the area for sample analysis of the platform. For example, the substrate material may provide reactive groups at the surface such as carboxyl, amino, hydroxyl, sulfhydryl, etc. Alternatively, the surface of the substrate may be derivatized so as to provide functional groups which will allow covalent attachment of a biomolecule. For example, the analysis area may be derivatized with silanes or other chemical groups; or the analysis area may be surface modified such as by plasma treatment and the like; etc.

Preferably the surface of the substrate platform is substantially smooth so as to allow uniform binding of biomolecules and effective analysis of molecules bound to the substrate using a variety of scanners, readers, detectors, etc. Alternatively, the surface of the substrate may be treated or coated so as to increase the binding capacity of the substrate. For example, a greater surface area for biomolecule binding may be achieved by roughening the surface of the substrate or by coating it with gel, particles, beads, etc. Preferably the substrate platform is optimized so as to provide the greatest binding capacity while still allowing efficient detection and evaluation of biomolecules bound to the surface.

The substrate platform is preferably constructed of materials which are resistant to extremes of low and high temperatures, i.e. temperatures of −5° C. to +105° C.; resistant to extremes of low and high pH, i.e. pH over a range of 1 to 13; resistant to sonication; and resistant to a wide variety of solvent conditions, i.e. high ionic strength and organic solvents such as ethanol, methanol, formamide, DMSO, etc. Particularly preferred substrate platforms are resistant to thermocycling such as performed during PCR. The substrate platforms are preferably resistant to multiple, i.e. about 10 to about 50 rounds of heating and cooling, such as would be obtainable with an art recognized thermocycler. The substrate platform may be constructed from a variety of materials such as plastics, quartz, silicon, polymers, gels, resins, carbon, metal, membranes, glass, etc. or from a combination of several types of materials such as a polymer blend, polymer coated glass, silicon oxide coated metal, etc. Particularly preferred substrate materials are polymers which contain a low intrinsic fluorescence emission, such as polycarbonate, Topas (trade name; available from Hoechst), polymethyl methacrylate (PMMA), and the like. In another preferred embodiment, the closed substrate platform is comprised of two parts adhered to each other, at the interface of which the microfluidic analysis platform is defined. In particular, a first bottom part having depressed in a planar surface thereof, a defined channel system is adhered to a second part, preferably a planar plastic member or film at the planar surfaces of the first part. The adhering of the two parts may be performed by using heat and/or adhesive optionally followed by a physical pressure to ensure a tight sealing and prevent any liquid or gas escaping through the seal.

By the term ‘resistant’ it is meant that the fundamental shape and properties of the substrate platform are not altered in a way which will affect the performance or functionality of the platform. For example, resistance is meant to indicate that exposure to an extreme temperature or pH will not cause the platform to melt, warp, etc. and that the platform will still be capable of covalently binding a biomolecule to the surface after such exposure.

The substrate platform may be constructed in a variety of shapes and sizes so as to allow easy manipulation of the substrate and compatibility with a variety of standard lab equipment such as microtiter plates, multichannel pipettors, microscopes, inkjet-type array spotters, photolithographic array synthesis equipment, array scanners or readers, fluorescence detectors, infra-red (IR) detectors, mass spectrometers, thermocyclers, high throughput machinery, robotics, etc. For example, the substrate platform may be constructed so as to have any convenient shape such as a meandering design, square, rectangle, circle, sphere, disc, slide, chip, film, plate, pad, tube or channel, strand, box, etc.

Preferably, the substrate platform is substantially flat with optional raised, depressed or indented regions to allow ease of manipulation. For example, the edges of the substrate platform may contain finger indents or ridges to facilitate handling and/or the surface may contain one or more wells which are capable of containing a specific volume of fluid. Particularly preferred substrate platforms are constructed in the general size and shape of a microscope slide and are compatible with any type of instrument that is capable of manipulating or evaluating a microscope slide.

When the substrate platform comprises a non-linear meandering fluid path such meandering design may comprise at least about one U-shaped meandering substrate platform, specifically, two parallel tubes connected via a 180⁰ semi-circular end, more preferably at least about three parallel tubes connected via a 180⁰ semi-circular end, most preferably at least about ten parallel tubes connected via a 180⁰ semi-circular end.

In a most preferred embodiment, the design of the sample analysis area is comprised of a straight narrow channel without any 180⁰ semi-circular turns. In some applications it might be preferred that the substrate platform is comprised of about three straight narrow channels, each with their own inlets, still more preferably the substrate platform is comprised of about five straight narrow channels, each with their own inlets. According to the present invention one straight narrow hybridization platform is sufficient, however more than one substrate platform may be used, each separate from the other and with each substrate platforms having individual inlets and outlets so that there is no cross-contamination between the samples.

The closed substrate platform can be comprised of at least one individual straight narrow channel to about five individual straight narrow channels.

As used herein, the term “individual straight narrow channels”, refers to the shape of substrate analysis area and each analysis area is completely separate from the next channel with its own inlet(s) and outlet(s) and there is no cross flow of sample between the individual chambers. Each chamber is therefore, a separate structure.

The substrate platform may contain one or more typically a plurality of channels or tubular sections that provide for flow and residence of test samples. For instance, the closed configuration systems of the invention suitably may have flow channels for transport and analysis of a test sample. The substrate platform also typically has one, or a plurality of analytical areas. Such distinct analytical areas may reside e.g. in a test area of an open system of the invention, where each area is defined by a defined line, channel or the like in the substrate platform surface.

The substrate platform may be constructed in a variety of colors or with a variety of markings which perform both decorative and/or functional purposes. For example, the substrate platform may be constructed of materials containing dyes or pigments to provide a colored product. The color can serve as a means of identification or may serve to reduce the intrinsic fluorescence of the substrate material. Additionally, the substrate may be clear or opaque. Preferably, the substrate material is clear so as to allow light to pass through the substrate platform. In another aspect of the invention, the substrate platform may contain markings such as numbers, words, pictures, company logos, etc. In a particularly preferred embodiment, the substrate platform contains a bar code to allow unique identification of individual platforms.

Markings on the substrate platform may be made by any art recognized method including, for example, application of stickers or other adhesives; application of ink directly onto the substrate surface by a well-defined deposit e.g. an inkjet printer, a pin-spotter, etc.; raised or indented regions formed during the molding of the substrate platform; etched or frosted areas added after molding of the substrate platform; etc. Preferably, the markings are located outside the area to be used for sample analysis and may serve to demarcate the sample analysis area.

The substrate platforms of the invention may be constructed by any of a variety of methods, e.g. injection molding, hot embossing, mechanical machining, etching, with injection molding and hot embossing being generally preferred.

Substrate platforms of the invention may be constructed in closed configuration. By ‘closed configuration’ it is meant that at least the area for sample analysis is enclosed within a container. Preferably, the container is at least substantially sealed (perhaps, except for inlet and outlet and/or vent units). It is also preferred that a substrate platform of the invention has integrated microfluidic structures for sample loading and washing.

In a preferred embodiment, a slide article, preferably rectangular and plastic, provides for a closed substrate platform with a “straight canal” The design of the analysis platform allows for liquid sample, injected through a narrow inlet port connected to a narrow tube. The inlet port is comprised of an adapter which fits into the inlet port and is conical in shape. The top part of the adapter is constructed to receive a pipette or a syringe needle or other fluid delivery device. The adapter is preferably comprised of rubber or a silicon-based material or other encasing material so that there is a tight contact between the fluid delivery device when fluid is delivered. The fluid travels from the adapter to the analysis area through a canal which is interrupted by a flow restrictor the flow restrictor serves the purpose of allowing for the liquid sample to be distributed evenly through the analysis area when pressure is applied by a user or automated system. The analysis area is preferably a straight and narrow canal with no turns at a defined area, probes are attached to the bottom of the canal. The fluid travels from the analysis area through a canal and arrives at a buffer chamber The buffer chamber also serves the purpose of relieving any pressure build up of that may be a consequence of the type of assay being performed, e.g. PCR. During the thermal cycles of a PCR assay, steam is produced resulting in a pressure build-up. Connected to the buffer chamber is a short capillary canal that opens into a meandering design waste. The waste area ends in a vent, shaped as a capillary chamber.

In another preferred embodiment, the slide is comprised of a bottom surface plastic structure as described above. The top surface of the slide is comprised of a thin plastic film or laminate which is placed over the bottom part of the slide and sealed using heat or adhesive followed by physical pressure to ensure airtight sealing and prevent any liquid or gas from escaping through the seal. In the surface of the bottom part slide a defined channel system has been depressed and a planar plastic substrate is adhered to the planar surface of the bottom part. At the interface of the bottom part and the plastic film, the microfluidic analysis platform of the invention is formed. The planar plastic substrate preferably provides sufficient rigidity to the substrate platform to withstand normal handling. A preferred thickness of the film or laminate is 100 μm or above, preferably about 150 μm or above. The adhesive layer is preferably present in a uniform layer between the surfaces of the two parts. The thickness of the adhesive layer is preferable below 30 μm and more preferred 15 μm or less. Preferably the total thickness of the planar plastic substrate and the adhesive is below 200 μm. The canal system depressed in the surface of the bottom part defines one part of the microfluidic analysis platform extending from the inlet to the vent. See FIG. 2A of the drawings. The surface of the inner planer plastic substrate is defining the other part of the microfluidic structure elements which forms the microfluidic analysis platform. The adhesive may be applied between the surfaces only at areas not participating in the formation of the channel system to avoid or decrease contact between sample or buffer fluid. Preferably, the adhesive is selected not to be dissolved in the fluids used for analysis.

This has the advantage of providing for a thin slide that can be used in many applications or instruments which normally employ a standard microscope slide. The slide is preferably about 1.3 mm thick, more preferably about 1 mm thick. Another major advantage of the slide is that the thin design, for example 1 mm, is of benefit as many standard confocal scanners have a fixed focus at this distance, whereas with thicker slides, the focus distance can be fine tuned only within a distance of +/−100 μm.

When the substrate platform comprises a non-linear meandering fluid path such meandering design may comprise at least about one U-shaped meandering substrate platform, specifically, two parallel tubes connected via a 180⁰ semi-circular end, more preferably at least about three parallel tubes connected via a 180⁰ semi-circular end, most preferably at least about ten parallel tubes connected via a 180⁰ semi-circular end.

In a most preferred embodiment, the design of the sample analysis area is comprised of a straight narrow channel without any 180⁰ semi-circular turns. In some applications it might be preferred that the substrate platform is comprised of about, three straight narrow channels, each with their own inlets, still more preferably the substrate platform is comprised of about five straight narrow channels, each with their own inlets. According to the present invention one straight narrow hybridization platform is sufficient, however more than one substrate platform may be used, each separate from the other and with each substrate platforms having individual inlets and outlets so that there is no cross-contamination between the samples.

In another preferred embodiment of the analysis area is a straight channel design leading from the inlet port and ending with the outlet port. The closed substrate platform may be comprised of at least about one straight channel to at least about five straight channels, each substrate platform as a separate entity with its own inlet and outlet ports so that there is no cross-contamination of samples.

Alternatively, the analysis area may contain one or more extended channels, including an extended channel that traverses repeatedly through the analysis area.

In systems having multiple flow channels, those flow channels may each have separate microfluidic systems (e.g. inlet and outlet ports, waste chambers), or the two or more channels may share a single microfluidic system.

The closed substrate platforms are suitably used in an array format, i.e. where multiple parameters are to be analyzed substantially simultaneously on the substrate platform. As referred to herein, the term “array” indicates a plurality of analytical data points that can be identified and address by their location in two or three-dimensional space, where i.e. identification can be established by the data point physical address.

Typically, the analysis systems of the invention utilize test samples that are in fluid form. For instance, test samples derived from humans or other mammals, or plant sample, may originate from blood, urine, or solid tissue or cells and will suitably be pre-treated to enrich or dilute the material to provide an optimized test sample.

In preferred analysis systems of the invention, the system will hold an accurate and reproducible volume of test sample fluid, e.g. a volume of about 5 μl to about 10 μl is preferred, although other volumes also can be employed if desired. Sample may be added at volumes of up to at least about 100 μl. During the analysis a part of a total amount of applied sample fluid will be present in the area for sample analysis. In a preferred embodiment the area for sample analysis and upstream microfluidic structures is designed to hold a volume of less than 10 μl.

In a further preferred embodiment of the closed substrate platform is that it is designed to operate with very small volumes of sample and buffer. The overall thickness of the substrate platform is preferably at least about 1 mm in order to make it as compatible with existing equipment designed for handling microscope slides as possible. This design is advantageous for applications wherein a limited number of spots, for example, at least about 300 spots, more preferably at least about 700 spots, most preferably at least about 1000 spots, need to be analyzed.

According to the invention, the sample or buffer is loaded by inserting a pipette in the sample port, which has the shape of a hole connecting the inlet chamber to the outside of the substrate platform. The inlet chamber is connected to a flow modulator, which is long and narrow to ensure that liquid injected into the chamber is in contact with all walls of the chamber and thus pushing any existing bubbles forward to the end of the chamber and out through a small channel connecting the inlet chamber to the analysis chamber. The diameter of the connecting channel is at least about 100 μm, more preferably the diameter of the connecting channel is at least about 250 μm, and most preferred the diameter of the connecting channels is at least about 500 μm.

On its way to the area for sample analysis, the liquid sample passes through a flow modulator or “pressure reducer” in the shape of a capillary tube. The channel narrows down from about 500 μm to about 100 μm for a length of at least about 1 mm and then expands to a connecting channel. The chamber is at least about 300 μm wide and at least about 2 mm long. At the opposite end of the analysis area the liquid exits through another channel with a diameter of at least about 500 μm. The lengths described here are illustrative and are not meant to be restrictive. Various dimensions can be used according to the physical and chemical properties of the liquid used, for example, viscosity, hydrophobicity, hydrophilicity, and the like.

From the above connecting channel, the sample or buffer runs to the analysis chamber, which is at least about 2 mm wide, at least about 20 mm long and at least about 50 μm deep, having a total volume of at least about 3 μL. For example, if a spotting pitch of 200 μm is used this chamber will be able to contain 600 spots. The lengths described here are illustrative and are not meant to be restrictive. Various dimensions can be used according to the physical and chemical properties of the liquid used, for example, viscosity, hydrophobicity, hydrophilicity, and the like.

When the sample or buffer exits the analysis area it runs through a buffer chamber surrounded on either side of capillary tubes before entering the waste chamber.

To ensure the rigidity of the substrate platform (where most of the internal volume is taken up by the waste chamber and thus not contributing to the rigidity) a number of supporting walls are placed in the waste chamber, giving the chamber the shape of a meander. The waste chamber may be separated from the analysis area by a narrow channel. This is to avoid diffusion of washed out hybridization components from the waste chamber into the analysis area.

The bottom of the slide may be indented directly beneath the analysis chamber for easy access with a peltier element or other heating/cooling device to control the temperature inside the chamber. Preferably the material thickness of the polymer that comprises the bottom portion of the slide is locally very thin, for example, preferred thickness is at least about 50 μm, more preferably the thickness is at least about 75 μm, most preferred thickness is at least about 100 μm, in the area directly beneath the chamber to ensure good heat transfer from/to the heating/cooling device. The thickness of the material may vary depending on the material used to construct the slide, wherein each material has different heat transfer properties.

The closed slide contains the area for sample analysis enclosed within a sealed container. The closed slide further contains an microfluidic analysis platform to permit sample loading, manipulation, washing, etc. The substrate platform in the closed slide may be constructed from any polymer which contains an acceptable level of intrinsic background fluorescence. Other suitable materials of constructions of analysis systems of the invention, including metals where analysis methods would include detecting electric signal or where a metal layer (e.g. gold) is deposited for mass spectrum analysis or other purposes.

Preferred closed analysis systems of the invention are sealed cartridges wherein an analytical area are housed within the cartridge. The structure can contain multiple inlet ports, typically two inlet ports, one for sample introduction, and one for washing solutions. The inlet ports can be operated by a variety of methods, e.g. standard pipettes, either manually or by robot. The inlet port provides introduction of the test sample into an analytical area, suitably holding the same preferred volumes of test sample fluid as discussed immediately above. The system will hold an accurate and reproducible volume of test sample fluid. A volume of from about 1 μl to about 10 μl is particularly preferred, where the introduction of a total of about 5 μl to about 30 μl will fill the microfluidic channels and analytical cavity. Optionally, a waste chamber can be integrated into the closed system to retain all added fluids including excess sample, washing buffers and other reagents. The overall dimensions of the closed system suitably may correspond to about 20 to about 30 mm wide, from about 70 to about 80 mm long and from about 0.1 to about 6 mm thick. A most preferred thickness of the slide is from about 0.6 mm to about 1.5 mm. Preferably, the closed system does not contain any moving parts or pumps. Movement of fluid through the system can be suitably accomplished by capillary forces and/or pressure introduced from outside the system such as during fluid introduction. The closed system should have a vent for escape of air as fluid passes into and through the system. The closed system suitably can be compatible with a microplate format, wherein a holder that has the same outer dimensions as a standard microplate will hold multiple closed systems of the invention, typically four closed systems.

The closed slide preferably contains a clear window within the top of the closed container corresponding the analysis area. The window allows the user to monitor liquid flow into and out of the analysis area and determine whether air bubbles are present. The window further allows biomolecules bound to the analysis area to be detected by a scanner, reader, etc. without opening the sealed container.

The closed slide preferably contains finger holds in the form of ridges or indents on the sides of the closed container. The finger holds are preferably paired on opposite sides of the closed container. The closed slide may also contain other surface contours such as recessed or raised regions which may perform functional or decorative purposes.

The casing of the closed slide may be constructed of a variety of materials, such as polycarbonate and the like. All or part of the casing of the closed slide may be transparent, opaque, frosted, etc. Additionally, all or part of the casing may be any one of or a variety of colors and may contain surface markings such as numbers, words, pictures, company logos, bar codes, etc. In a particularly preferred embodiment, the casing may contain labels for the inlet and outlet ports to indicate, for example, where sample and wash materials may be introduced and waste or air may be expelled (i.e. vents), etc.

The inlet port may contain a septum (i.e. a partition or dividing wall) which serves as a self-closing inlet to prevent contamination. The septum preferably will open upon contact with a pipette tip, or other instrument used to introduce liquid into the slide, and will close or reseal upon removal of the pipette tip or other such instrument. The septum is preferably constructed of a sealable material such as, for example elastomer, silicone rubber, teflon, etc. As used herein, the term “sealable” means that after introduction of sample, the septum will be able to close and maintain a closed or sealed environment without introduction of unwanted air, liquid, etc. from the outside and without substantial loss of air, fluid, etc. from the inside.

The sample or inlet ports may also be fitted with a rubber adaptor, or silicon-based material, which is conical in shape and fits tightly into the inlet ports. The adapter fits, at one end into an inlet at the bottom face of the slide and the top end is adapted to receive a pipette or syringe tip.

In a most preferred embodiment, the waste chamber is of meandering design, ending in a vent shaped as a capillary canal. The waste area does not contain any fleece or other fluid absorbing material but the force used when the sample is introduced into the inlet or sample port is the force that drives the sample through the microfluidic device and into the waste area.

In another embodiment the waste area contains an absorbent material such as a gel, cloth, fleece. etc. which is capable of soaking up the waste fluid and preventing any backflow of the waste material into the analysis area. The sorbent material is then able to work as a capillary pump, enabling the drawing of the liquid out of the fluidic structures and into the waste chamber, driven by the very high capillary force of the fleece.

For optimal coupling of the fluidic system to the fleece a special design element has been developed for controlled and continuous flow of the liquid into the waste chamber. The inlet into the waste chamber consists of a neck with notch-structured zones, preferably star shaped, of the waste inlet connectably coupled to the waste chamber, preferably to the absorbing material inside the waste chamber of the fluidic device. The notches are the coupling element which thereby cause increased contact surface between the neck and the fleece. The wedge-shaped notches cause an initial sucking force due to capillary forces. See European patent application serial no. EP 1 013 341 A2.

In the meandering design or straight channel design substrate analysis platform, the waste area may not contain fleece. The pressure applied when introducing the sample into the inlet port is sufficient to drive the sample through the microfluidic structure of the slide element.

The microfluidic structure comprising the buffer chamber is preferably surrounded by two capillary tubes, which also may be referred to as “capillary stops.” The first capillary stop holds the liquid during the filling of the device, while the second stop halts the liquid during a method such as a heating step which is necessary for the analysis or assay reaction. Such combination of stops enables to stop the flow before thermal expansion and after thermal expansion of the liquid.

Additional stops may be incorporated at desired sites, such as between the inlet chamber and the washing buffer inlet. This stop avoids the flow of liquid from the filling chamber backwards into the buffer inlet.

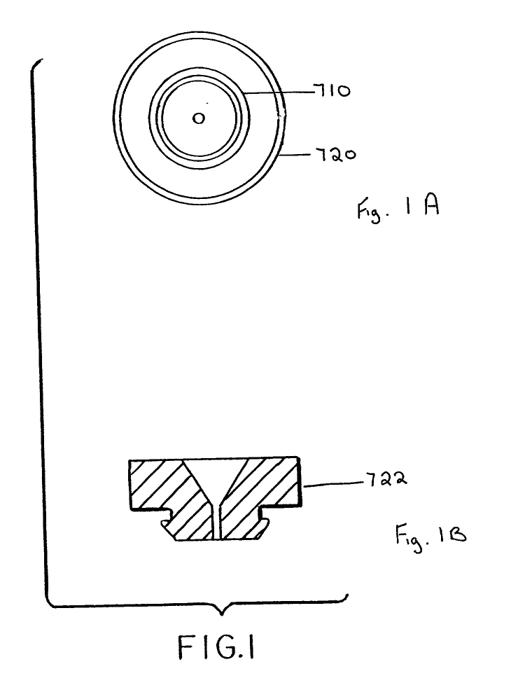

Referring now specifically to the drawings, an illustrative example of a microfluidic analysis platform is shown in FIG. 2. As shown, the microfluidic analysis platform is preferably rectangular and plastic, and provides for a sample analysis area in the shape of a “straight canal”. The design of the microfluidic analysis platform allows for liquid sample to be injected through a narrow inlet port connected to a narrow tube 730. The inlet port is comprised of an adapter 710, (see FIG. 1A), which fits into the inlet port 720 (see FIG. 1A), and is preferably conical in shape 722 (see FIG. 1B). The top part of the adapter is constructed to receive a pipette or a syringe needle or other fluid delivery device. The adapter is preferably comprised of rubber or a silicon-based material or other encasing material so that there is a tight contact between the fluid delivery device when fluid is delivered. The fluid travels from the adapter, through a flow modulator or “pressure reducer” 730 which opens up into a wider chamber 740. From this chamber, the sample travels to the sample analysis area 750. The flow restrictor serves the purpose of allowing the liquid sample to be distributed evenly through the sample analysis area when pressure is applied by a user or automated system. The sample analysis area is preferably a straight and narrow canal with no turns 750 (see FIG. 2A). At a defined area, probes are attached to the bottom of the canal. The fluid travels from the analysis area through a canal 760 (see FIGS. 2A and B) and arrives at a buffer chamber 770 (see FIGS. 2A and B). As discussed, the buffer chamber also can serve the purpose of relieving any pressure build up of that may be a consequence of the type of assay being performed, e.g. PCR. During the thermal cycles of a PCR assay, steam is produced resulting in a pressure build-up. Connected to the buffer chamber is a short capillary canal that opens into a meandering design waste area 780 (see FIG. 2). The waste area ends in a vent, shaped as a capillary chamber 790 (see FIG. 2).

An illustrative example of using a substrate analysis platform of the invention is for single nucleotide polymorphism (SNP) analysis. This example is not meant to be restrictive in any way but is illustrative of how the analysis platform is used. A first step provides for the preparation of solutions comprising the desired capture probes. For alignment purposes or a method to detect the location of the capture probes a solution of, for example, a t-15 oligo modified in the 5′-end with anthraquinone and in the 3′-end with biotin as a detector molecule is also prepared. The solutions are spotted on the substrate platform by conventional means such as for example, a BioChip Arrayer I from Packard BioChip Technologies.

Replicates of an array is spotted on the substrate platform. Each array may be comprised of for example, about a row of 4 markers at the top and at the bottom to indicate the outer boundaries of the array, and in the middle rows, for example, about 10 middle rows, the capture probes of each SNP are printed in duplicates. Thus, a user may have a total of at least about 10 replicates of each capture probe. The arrays may be spotted in the sample analysis area on the platform or the opposing planar plastic member.

The spotted area is irradiated for at least 90 seconds, via conventional methods, such as for example, a Stratalinker 2400 from Stratagene, to allow the capture probes to form a covalent bond to the polymer. After washing, the top section of the substrate platform is placed on the base or bottom section of the closed platform substrate and attached by adhesive or any other means to form airtight closed channels and chamber.

For each of the different alleles in the SNP's capture probes, a synthetic DNA oligomer is synthesized and labeled with biotin in the 5′-end (“Targets”). Conventional methods are used for synthesizing the oligomer such as, a DNA-synthesizer which can be purchased commercially. A solution of the targets in an appropriate buffer solution (see, for example, Maniatis) is prepared at the desired concentration and is introduced into the inlet or sample port. The sample flows through the chambers as described above. The platform is left to hybridize over night at room temperature.

After hybridization the target solution is flushed out of the analysis chamber by applying, for example, at least about 30 μL of washing buffer through the inlet port with a standard pipette. Subsequently, a solution of Cy5-labled streptavidin is added through the sample port completely filling the analysis chamber, and the platform is then left to incubate for 1 hour at room temperature.

Hybridization is observed due to, for example, the biotin label, allowing images to be produced using for example, a fluorescent microscope equipped with an XBO lamp, an emission/excitation filter set of 650 nm/670 nm and a 5× objective. Thus one can detect variations in single nucleotide polymorphisms.

The slides or substrate platforms of the invention may be used for any application which typically utilizes a standard microscope slide. For example, the slides may be used for evaluation of samples such as smears, sections, liquid samples, etc. The samples are preferably applied to the analysis area of the slide. The slides of the invention may be used in conjunction with any type of equipment, instrument or machine typically used to manipulate or evaluate a standard microscope slide.

The slides or substrate platforms of the invention may also be used for binding or immobilizing biomolecules. Biomolecules are preferably bound to the analysis area of the slide. The term ‘biomolecule’ as used herein is meant to indicate any type of nucleic acid, modified nucleic acid, protein, modified protein, peptide, modified peptide, small molecule, lectin, polysaccharide, hormone, drug, drug candidate, etc. Biomolecule binding may be covalent, non-covalent, direct, indirect, via a linker, targeted, random, etc. Biomolecules may be attached through a single attachment to the surface of the substrate platform or via multiple attachments for a single biomolecule. Any type of binding method known to the skilled in the art may be used.

Nucleic acids which may be immobilized onto the substrate include RNA, mRNA, DNA, LNA, PNA, cDNA, oligonucleotides, primers, nucleic acid binding partners, etc. The nucleic acids for immobilization may be modified by any method known in the art. For example, the nucleic acids may contain one or more modified nucleotides, etc. and/or one or more modified intemucleotide linkages, such as, phosphorothioate, etc. Particularly preferred 3′ and/or 5′ modifications include amino modifiers, thiols, and photoreactive ketones particularly quinones, especially anthraquinones.

Particularly preferred modified nucleic acids are those containing one or more nucleoside analogues of the locked nucleoside analogue (LNA) type as described in WO 99/14226, which is incorporated herein by reference. Additionally, the nucleic acids may be modified at either the 3′ and/or 5′ end by any type of modification known in the art. For example, either or both ends may be capped with a protecting group, attached to a flexible linking group, attached to a reactive group to aid in attachment to the substrate surface, etc.

As disclosed in WO 99/14226, LNA are a novel class of DNA analogues that form DNA- or RNA-heteroduplexes with exceptionally high thermal stability. LNA monomers include bicyclic compounds as shown immediately below:

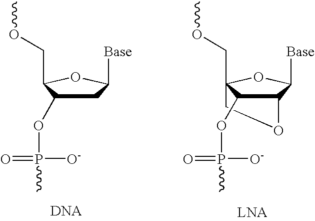

References herein to Locked Nucleoside Analogues, LNA or similar term refers to such compounds as disclosed in WO 99/14226.

LNA monomers and oligomers can share chemical properties of DNA and RNA; they are water soluble, can be separated by agarose gel electrophoresis, can be ethanol precipitated, etc.

Introduction of LNA monomers into either DNA, RNA or pure LNA oligonucleotides results in extremely high thermal stability of duplexes with complimentary DNA or RNA, while at the same time obeying the Watson-Crick base pairing rules. In general, the thermal stability of heteroduplexes is increased 3-8° C. per LNA monomer in the duplex. Oligonucleotides containing LNA can be designed to be substrates for polymerases (e.g. Taq polymerase), and PCR based on LNA primers is more discriminatory towards single base mutations in the template DNA compared to normal DNA-primers (i.e. allele specific PCR). Furthermore, very short LNA oligos (e.g. 8-mers) which have high Tₘ's when compared to similar DNA oligos, can be used as highly specific catching probes with outstanding discriminatory power towards single base mutations (i.e. SNP detection).

Oligonucleotides containing LNA are easily synthesized by standard phosphoramidite chemistry. The flexibility of the phosphoramidite synthesis approach further facilitates the easy production of LNA oligos carrying all types of standard linkers, fluorophores and reporter groups.

As discussed above, these oligonucleotides may be used in the closed substrate analysis platform for the construction of high specificity oligo arrays e.g. wherein a multitude of different oligos are affixed to a solid surface in a predetermined pattern (Nature Genetics, suppl. vol. 21, January 1999, 1-60 and WO 96/31557). The usefulness of such an array, which can be used to simultaneously analyze a large number of target nucleic acids, depends to a large extend on the specificity of the individual oligos bound to the surface. The target nucleic acids may carry a detectable label or be detected by incubation with suitable detection probes which may also be an oligonucleotide of the invention.

An illustrative example for use of a closed substrate analysis platform is for identification of a nucleic acid sequence capable of binding to a biomolecule of interest. This is achieved by immobilizing a library of nucleic acids onto the substrate surface so that each unique nucleic acid is located at a defined position to form an array. The array is then exposed to the biomolecule under conditions which favor binding of the biomolecule to the nucleic acids. Non-specifically binding biomolecules are washed away using mild to stringent buffer conditions depending on the level of specificity of binding desired. The nucleic acid array is then analyzed to determine which nucleic acid sequences bound to the biomolecule. Preferably the biomolecules would carry a fluorescent tag for use in detection of the location of the bound nucleic acids.

The closed substrate platforms, with an immobilized array of nucleic acid sequences may be used for determining the sequence of an unknown nucleic acid; single nucleotide polymorphism (SNP) analysis; analysis of gene expression patterns from a particular species, tissue, cell type, etc.; gene identification; etc.

Nucleic acids for immobilization onto the substrate may be either single stranded or double stranded and preferably contain from about 2 to about 1000 nucleotides, more preferably from about to 2 to about 100 nucleotides and most preferably from about 2 to about 30 nucleotides.

Polypeptides may also be immobilized onto the surface of the substrate platform. Particularly preferred polypeptides for immobilization are receptors, ligands, antibodies, antigens, enzymes, nucleic acid binding proteins, etc. Polypeptides may be modified in any way known to those skilled in the art. For example, polypeptides may contain one or more phosphorylations, glycosylations, etc. Additionally, polypeptides may be attached to a flexible linker and/or reactive to group to facilitate binding to the surface of the substrate.

Polypeptides for immobilization onto the substrate may be monomeric, dimeric or multimeric and preferably contain from about 2 to about 1000 amino acids, more preferably from about 2 to about 100 amino acids and most preferably from about 2 to about 20 amino acids.

Polypeptides and nucleic acids for immobilization onto the substrate may be prepared separately and then applied onto the substrate surface. Methods for preparation of nucleic acids/oligos are known in the art, for example phosphoramidite chemistry.

Polypeptides and nucleic acids may be applied to the surface of the substrate by any method well known in the art. For example, polypeptides or nucleic acids may be manually pipetted onto the surface or applied using a robotics system. Preferably, polypeptides or nucleic acids are applied to the substrate using a micro spotting technique such as may be achieved with inkjet type technology.

The analysis substrates of the invention also may be employed for relatively high density analysis, e.g. loaded for analysis with at least about 100 unique polypeptide sequences or nucleotides sequences per cm² of analysis area; or at least about 200, 300, 400, 500, 600, 700, 800 or 900 unique polypeptide sequences or nucleotides sequences per cm²of analysis area.

Biomolecules may be attached to the surface of the substrate using any method known in the art. Preferably biomolecules are attached to the surface using a photochemical linker which becomes active upon exposure to light of a defined wavelength. Most preferably biomolecules are attached to the surface using a quinone photolinker. Methods for photochemical immobilization of biomolecules using quinones are described in WO 96/31557, which is incorporated herein by reference.

Biomolecules may be attached directly to the analysis substrate surface or may be attached to the substrate through a flexible linker group. The linker group may be attached to the surface of the substrate before immobilization of the biomolecule or the linker group may be attached to the biomolecule before immobilization onto the substrate. For example, a nucleic acid may be modified with a linker group at either the 3′ or 5′ end prior to immobilization onto the substrate. Alternatively, an unmodified nucleic acid may be attached to the substrate which has been coated with linker groups. Similarly, a polypeptide may be modified with a group at either the amino terminus or carboxy terminus prior to immobilization onto the substrate. Alternatively, an unmodified polypeptide may be immobilized onto the substrate which has been coated with linker groups. The linker groups may be attached at any location within a nucleic acid or polypeptide chain but are preferably attached at either end of the polypeptide or amino acid chain. Linker groups for immobilization of biomolecules are well known in the art. Any linker group known in the art may be used for attachment of biomolecules.

Alternatively, polypeptides and nucleic acids may be synthesized in situ on the surface of the substrate. Methods for in situ synthesis of polypeptides and nucleic acids are well known in the art and include photolithographic techniques, protection/deprotection techniques, etc.

The analysis area of the substrate platforms of the invention may be coated with a single biomolecule, with a random mixture of biomolecules or with a mixture of biomolecules wherein each unique biomolecule is located at a defined position so as to form an array. In a preferred embodiment the analysis area is coated with a library of polypeptides or nucleic acids wherein each unique nucleic acid or amino acid sequence is located at a defined location within the analysis area.

The invention also provides methods for using the substrate platforms of the invention for carrying out a variety of bioassays. Any type of assay wherein one component is immobilized may be carried out using the substrate platforms of the invention. Bioassays utilizing an immobilized component are well known in the art. Examples of assays utilizing an immobilized component include for example, immunoassays, analysis of protein-protein interactions, analysis of protein-nucleic acid interactions, analysis of nucleic acid-nucleic acid interactions, receptor binding assays, enzyme assays, phosphorylation assays, diagnostic assays for determination of disease state, genetic profiling for drug compatibility analysis, SNP detection, etc.

Identification of a nucleic acid sequence capable of binding to a biomolecule of interest could be achieved by immobilizing a library of nucleic acids onto the substrate surface so that each unique nucleic acid was located at a defined position to form an array. The array would then be exposed to the biomolecule under conditions which favored binding of the biomolecule to the nucleic acids. Non-specifically binding biomolecules could be washed away using mild to stringent buffer conditions depending on the level of specificity of binding desired. The nucleic acid array would then be analyzed to determine which nucleic acid sequences bound to the biomolecule. Preferably the biomolecules would carry a fluorescent tag for use in detection of the location of the bound nucleic acids.

Assays using an immobilized array of nucleic acid sequences may be used for determining the sequence of an unknown nucleic acid; single nucleotide polymorphism (SNP) analysis; analysis of gene expression patterns from a particular species, tissue, cell type, etc.; gene identification; gene deletion analysis, etc.

Assays using immobilized polypeptides are also provided by the methods of the invention. For example, an immobilized array of peptides could be exposed to an antibody or receptor to determine which peptides are recognized by the antibody or receptor. Preferably the antibody or receptor carriers a fluorescent tag for identification of the location of the bound peptides. Alternatively, an immobilized array of antibodies or receptors could be exposed to a polypeptide to determine which antibodies recognize the polypeptide.

The slides of the invention may also be used for assays not involving immobilized biomolecules. For example, the slides may be used for cell sorting, including living cells (inclusive of viruses), which sorted cells then may be subjected to analysis.

Analysis substrates of the invention also may be modified as appropriate for particular assays. For instance, in closed analysis systems of the invention, one or more surfaces of the internal analysis surface can be pre-treated to facilitate attachment and/or growth of cells for analysis.

All documents mentioned herein are incorporated herein by reference in their entirety.

The invention has been described in detail with reference to preferred embodiments thereof. However, it will be appreciated that those skilled in the art, upon consideration of this disclosure, may make modifications and improvements within the spirit and scope of the invention.

What is claimed is:

1. A closed substrate platform comprising:
a container comprising an area for sample analysis and a microfluidic analysis platform,
the container comprising (i) at least one inlet for the introduction of fluid to the sample analysis area and (ii) an outlet for removal of fluid from the sample analysis area;
a vent for expulsion of air from the container.

2. The substrate platform of claim 1, wherein the container comprises at least two parts adhered to each other, wherein at the interface of the two parts the microfluidic analysis platform is defined.

3. The substrate platform of claim 1 or 2, wherein a first substrate platform part in a planar surface thereof has depressed a defined channel system and a second substrate platform part is a planar substrate adhered to the first part planar surface.

4. The substrate platform of claim 2 or 3, wherein the two parts are adhered together with an adhesive.

5. The substrate platform of any one of claims 2 through 4, wherein the planar substrate is a transparent plastic member.

6. The substrate platform of claim 1, wherein the thickness thereof is 1.5 mm or less.

7. The substrate platform of claim 6, wherein the thickness thereof is about 1 mm.

8. The substrate platform of claim 1 wherein the sample analysis area comprises a plurality of biomolecules.

9. The substrate platform of any one of claims 1 through 8 wherein the microfluidic analysis platform comprises the sample analysis area.

10. The substrate platform of any one of claims 1 through 9 wherein the microfluidic analysis platform comprising a non-linear meandering flow path.

11. The substrate platform of any one of claims 1 through 10 wherein the substrate platform comprises a plurality of inlets.

12. The substrate platform of any one of claims 1 through 11 wherein the substrate platform comprises two inlets.

13. The substrate platform of any one of claims 1 through 12 wherein the inlet comprises an adapter to receive a fluid delivery device.

14. The substrate platform of claim 13 wherein the adapter is conical shaped.

15. The substrate platform of claim 13 or 14 wherein the adapter provides a substantially fluid impervious engagement of the fluid delivery device.

16. The substrate platform of any one of claims 13 through 15 wherein the fluid delivery device is a pipette or syringe.

17. The substrate platform of any one of claims 1 through 15 wherein delivery of fluid into the substrate provides force for fluid flow through the substrate platform.

18. The substrate platform of any one of claims 1 through 17 further comprising a fluid flow modulator.

19. The substrate platform of claim 18 wherein the flow modulator is positioned in the fluid flow path between an inlet and sample analysis area.

20. The substrate platform of claim 18 or 19 wherein the flow modulator reduces flow rate of fluid delivered through an inlet.

21. The substrate platform of claim 18 through 20 wherein the flow modulator comprises a capillary channel of reduced cross-sectional area relative to the flow path prior to the flow modulator.

22. The substrate platform of any one of claims 1 through 21 wherein a buffer area is after the sample analysis area.

23. The substrate of any one of claims 1 through 22 wherein a waste area is after the sample analysis area.

24. The substrate platform of claim 22 or 23 wherein a waste area is after the buffer area.

25. The substrate platform of claim 23 or 24 wherein the waste area comprises the vent.

26. The substrate platform of any one of claims 1 through 25 wherein the sample analysis area comprises one or more biomolecules.

27. The substrate platform of any one of claim 1 through 26 wherein the sample analysis area comprises one or more nucleic acid compounds or peptide compounds.

28. A closed substrate platform for analysis of biomolecules comprising:
a container comprising an area for sample analysis and a microfluidic analysis system comprising a non-linear flow path,
the container comprising (i) at least one inlet for the introduction of fluid to the sample analysis area and (ii) an outlet for removal of fluid from the sample analysis area;
a vent for expulsion of air from the container,
the sample analysis area comprising one or more biomolecules.

29. The substrate platform of claim 28 wherein the substrate platform comprises a plurality of inlets.

30. The substrate platform of claim 28 or 29 wherein the substrate platform comprises a fluid flow modulator between an inlet and sample analysis area.

31. The substrate platform of any one of claims 28 through 30 wherein the flow modulator reduces flow rate of fluid delivered through an inlet.

32. The substrate platform of any one of claims 28 through 31 wherein a buffer area is after the sample analysis area, and a waste area after the buffer area, the waste area comprising the vent.

33. The substrate platform of any one of claims 28 through 32 wherein the sample analysis area comprises one or more nucleic acid compounds or peptide compounds.

34. A closed substrate platform comprising:
a container comprising an area for sample analysis and a microfluidic analysis platform,
the container comprising (i) at least one inlet for the introduction of fluid to the sample analysis area and (ii) an outlet for removal of fluid from the sample analysis area,
the container comprising at least two parts adhered to each other, wherein the two parts define the microfluidic analysis platform;
a vent for expulsion of air from the container.

35. The substrate platform of claim 34, wherein a first substrate platform part in a planar surface thereof has depressed a defined channel system and a second substrate platform part is a planar substrate adhered to the first part planar surface.

36. The substrate platform of claim 34 or 35 wherein the two parts are adhered together with an adhesive.

37. The substrate platform of any one of claims 34 through 36 wherein the planar substrate is a transparent plastic member.

38. The substrate platform of any one of claims 34 through 37 wherein the microfluidic analysis platform comprising a non-linear meandering flow path.

39. The substrate platform of any one of claims 34 through 38 wherein the sample analysis area comprises one or more biomolecules.

40. The substrate platform of any one of claim 34 through 38 wherein the sample analysis area comprises one or more nucleic acid compounds or peptide compounds.

41. Use of the substrate platform of any one of claims 1 through 40 for sample analysis.

42. Use of the substrate platform of any one of claims 1 through 40 for detecting DNA sequence variation, DNA sequencing, SNP analysis, genotyping, deletion analysis, gene expression and the like.

43. A method for sample analysis comprising applying a sample to the substrate platform of any one of claims 1 through 40, and evaluating the sample.

44. The method of claim 43 wherein the sample is a fluid.

45. The method of claim 43 or 44 wherein the sample is delivered to the substrate platform through a pipette or syringe.

46. The method of any one of claims 43 through 45 wherein delivery of the sample into the substrate platform provides force sufficient for flow of the sample through the platform.

47. A method for providing a closed substrate platform suitable for analysis of biomolecules, comprising:
providing an analysis platform part having a defined channel system depressed in a planar surface thereof, to provide an analysis sample flow path; and
applying a planar substrate over the channel system to provide a closed sample flow path.

48. The method of claim 47 wherein the planar substrate is a plastic member.

49. The method of claim 47 or 48 wherein the planar substrate is laminated to the top surface of the analysis substrate platform.

50. The method of any one of claims 47 through 49 wherein the sample flow path is non-linear.
